(19) United States
(12) Patent Application Publication
(10) Pub. No.: US 2008/0238675 A1
(43) Pub. Date: Oct. 2, 2008

(54) RFID TAG SYSTEM

(75) Inventor: Wei-Sheng YANG, Tanzih Township (TW)

Correspondence Address: EGBERT LAW OFFICES, 412 MAIN STREET, 7TH FLOOR, HOUSTON, TX, 77002, US

(73) Assignee: GIGATEK INC., Tanzih Township (TW)

(21) Appl. No.: 11/695,572

(22) Filed: Apr. 2, 2007

(51) Int. Cl. G08B 13/24

(52) U.S. Cl. 340/572.1

(57) ABSTRACT

The present invention provides an applied RFID tag system with the RFID tag assembled between the first and second portions of an object. When the first and second portions are separated or misaligned, the RFID tag will be deformed and damaged, making it impossible to be identified with a predefined radio frequency, namely, it cannot be identified by card reader. According to the damage information, the operator could learn the unsealing or loosening state of the products, thus ensuring quick and accurate quality control and improved fault detection.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a system with an RFID tag, and more particularly to an innovative RFID tag that allows first and second portions of the tagged object to be separated or misaligned, thus serving the purpose of fast and accurate product control.

2. Description of Related Art Including Information Disclosed Under 37 CFR 1.97 and 37 CFR 1.98

A Radio Frequency Identification (RFID) tag refers generally to components comprising RF IC (Integrated Circuit) chips below 2 cm and antenna. The special reader/writer allows reading or writing data externally. Due to the features of the RFID, the product properties and manufacturing date, etc., can be accessed by radio frequency, enabling the users to streamline the logistics services in an efficient way. Thus, there is now a growing trend of replacing traditional bar codes and magnetic cards.

The short-range RFID is already applied to factory automation and product marketing, while long-range RFID is applied to a charging system and vehicle ID identification. The most common RFID applications, for example, include embedded chip for pets, followed by access control systems and safety systems in some well-known hotels.

As for the common bottled products under present market demand, these products are deemed intact if the bottle caps are sealed or unloosened during manufacturing, shipping or prior to marketing. However, the product information, for example, the product quality, cannot be accessed quickly without manual operation during the manufacturing process or on-site inspection, leading to inefficient quality control or inspection.

In addition, certain components of many precise products are possibly loosened after assembly. In such case, the finished products cannot function well. So, quality control is of crucial importance in this context. As the current detection technology relies upon manual operation, fault detection cannot be realized quickly, resulting in significant human resources expenditures.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The present invention provides an innovative telecom IC of an RFID tag to be assembled between first and second portions of an object. When the first and second portions of the object are separated or misaligned, the RFID tag will be deformed and damaged, making it impossible to be identified with a predefined radio frequency, namely, it cannot be identified by a card reader. According to the damage information, the operator detects the unsealing or loosening state of the products. So, the present invention can be widely applied to various product structures, enabling quality control and fault detection during manufacturing, shipping or prior to marketing. As compared with the prior art manual fault detection, the present invention provides quicker and more accurate fault detection, thus reducing the manufacturing cost with improved applicability and economic efficiency.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of the preferred embodiment of the present invention.

FIG. 2 shows an assembled sectional view of the preferred embodiment of the present invention.

FIG. 3 shows another sectional view of the operation of the preferred embodiment of the present invention.

FIG. 4 shows a schematic view of the detection of the status of the damaged antenna of the present invention, which cannot be identified by the card reader.

FIG. 5 shows a perspective view of another embodiment of the object of the present invention.

FIG. 6 shows a perspective view of another embodiment of the object of the present invention.

FIG. 7 shows a perspective view of another embodiment of the object of the present invention.

FIG. 8 shows a schematic view of another embodiment of the RFID tag of the present invention.

FIG. 9 shows a schematic view of another embodiment of the RFID tag of the present invention.

FIG. 10 shows a schematic view of another embodiment of the RFID tag of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

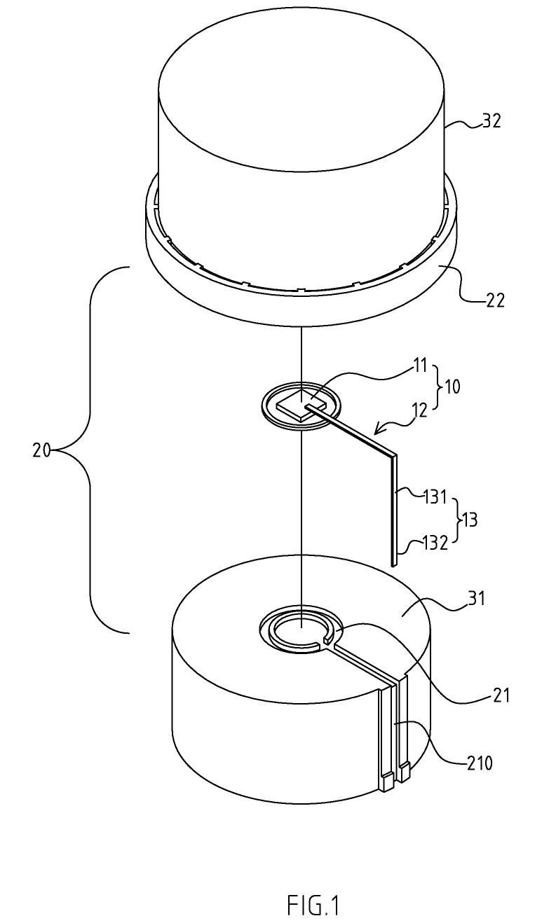

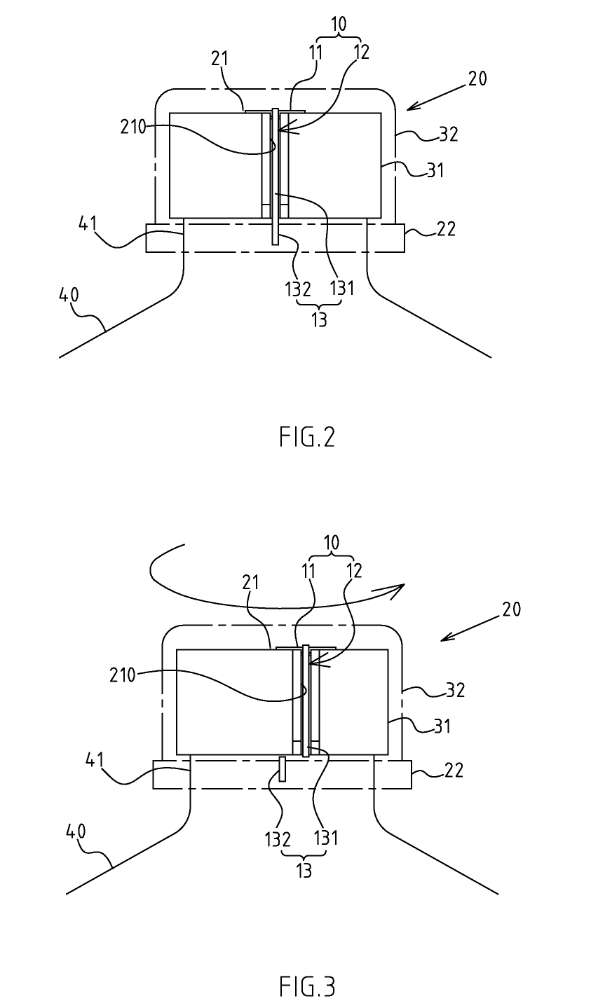

FIGS. 1 and 2 depict preferred embodiments of improved structure of an RFID tag of the present invention. The embodiments are provided only for explanatory purposes. The RFID tag 10 is attached onto an object 20, which may be packing or packaging (e.g. cap or packaging bag), or a seal, or a lifting card.

The object 20 comprises a first portion 21 and a second portion 22, which can be separated from or misaligned with each other.

The RFID tag 10 comprises a telecom IC 11 (e.g. silicon chip), and an antenna 12 linked to the telecom IC 11, of which a protruding end 13 is defined at the antenna 12. The telecom IC 11 is assembled on the first portion 21 of object 20. The protruding end 13 of antenna 12 comprises a first part 131 positioned on the first portion 21, and a second part 132 positioned on the second portion 22.

For example, the object 20 of the preferred embodiment is a bottle cap comprising an inner cap 31 and outer cap 32, which define separately said first portion 21 and second portion 22. The first portion 21 is assembled into a groove at a top of inner cap 31, so that the telecom IC 11 of antenna 12 can be positioned. The first portion 21 also contains a long groove 210 extending towards inner cap 31, so that protruding end 13 of antenna 12 is embedded securely. The outer cap 32 is mounted externally onto inner cap 31 via an injection molding machine, and the second part 132 of protruding end 13 of antenna 12 is embedded into second portion 22 at bottom of outer cap 32. In this preferred embodiment, the second portion 22 is a fixing ring used to lock the bottle cap onto the bottle mouth 41 of container 40. Referring to FIG. 3, when the bottle cap is loosened, the first part 131 of protruding end 13 of antenna 12 will move along with the rotation of first portion 21; but, the second part 132 at the second portion 22 remains unchanged. So, the first part 131 of protruding end 13 of antenna 12 is split from the second part 132. In such a broken state, the normal signal receiving/transmitting of antenna 12 is adversely affected. Since the signal receiving/transmitting function of the antenna will be affected, even in the case of slight deformation of shape, the antenna of the preferred embodiment creates a deformable second part 132.

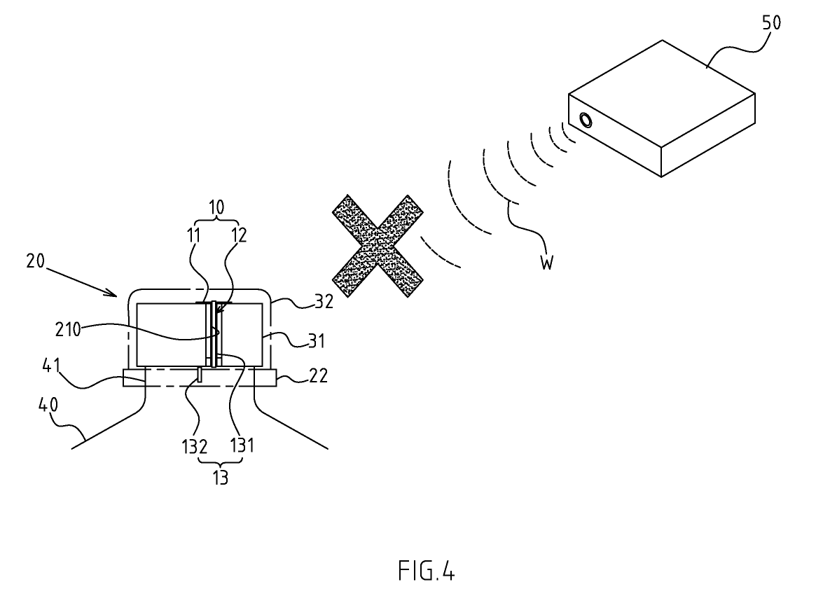

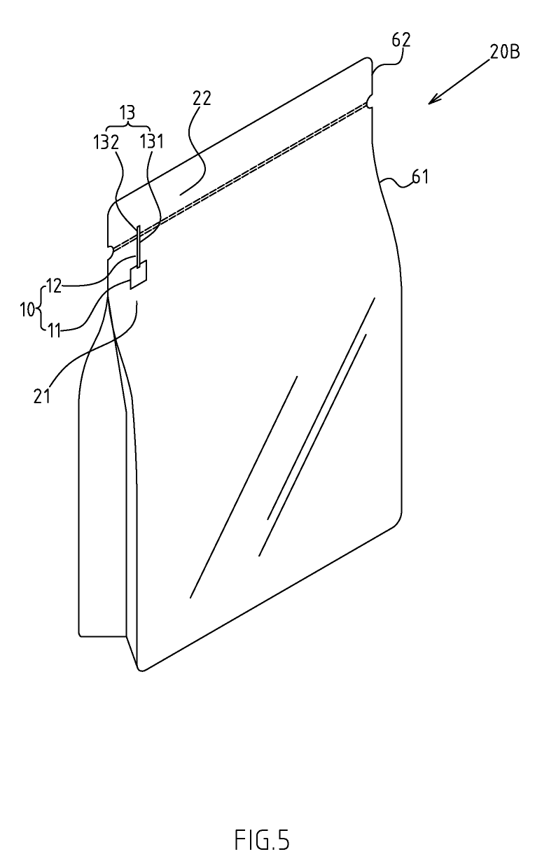

Referring to FIG. 4, as the first part 131 of protruding end 13 of antenna 12 is split from the second part 132, it is impossible to identify the RFID tag 10 with predefined radio frequency W, namely, it cannot be identified by card reader 50. According to the damage information displayed on the card reader 50, the operator could ascertain the real-time opening state of the container 40.

Referring to FIG. 5, said object 20B is a packaging bag, which comprises a bag body 61 and a tear tape 62 at the opening of the bag body 61, thus forming said first portion 21 and second portion 22. As for the RFID tag 10 of the present invention, the first part 131 of protruding end 13 of the antenna 12 is fixed onto the first portion 21, and the second part 132 is fixed onto the second portion 22. When the tear tape 62 is torn off, the second part 132 on the protruding end 13 of antenna 12 will be removed, leading to the damage of RFID tag 10.

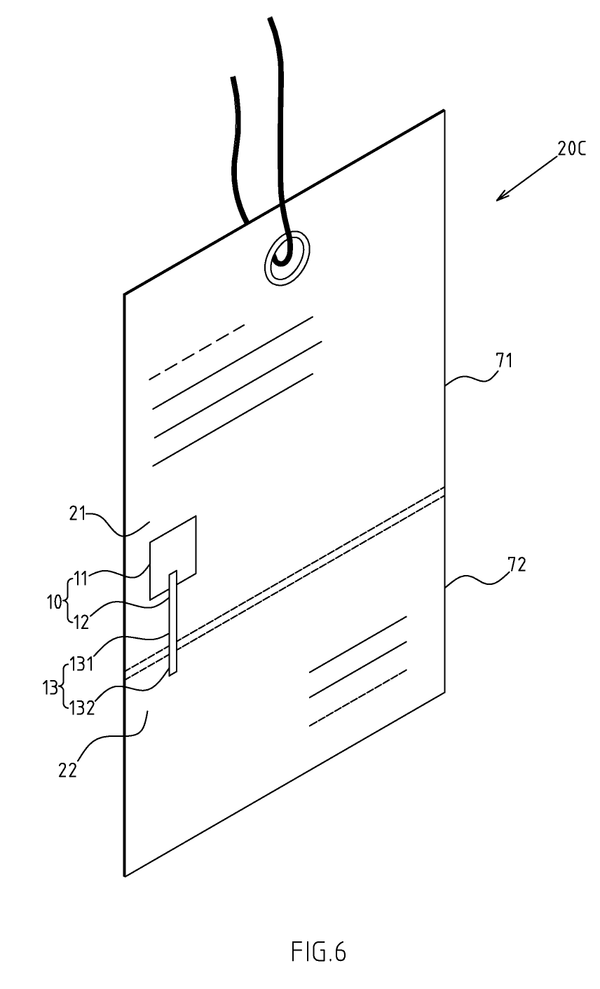

Referring to FIG. 6, said object 20C may be a lifting card, which comprises a main card 71 and a secondary card 72 forming said first portion 21 and second portion 22. The first part 131 of protruding end 13 of antenna 12 is fixed at the first portion 21, and the second part 132 fixed at the second portion 22. When the secondary card 72 is separated from main card 71, the second part 132 of the protruding end 13 of antenna 12 will be split with the first part 131, leading to the damage of RFID tag 10.

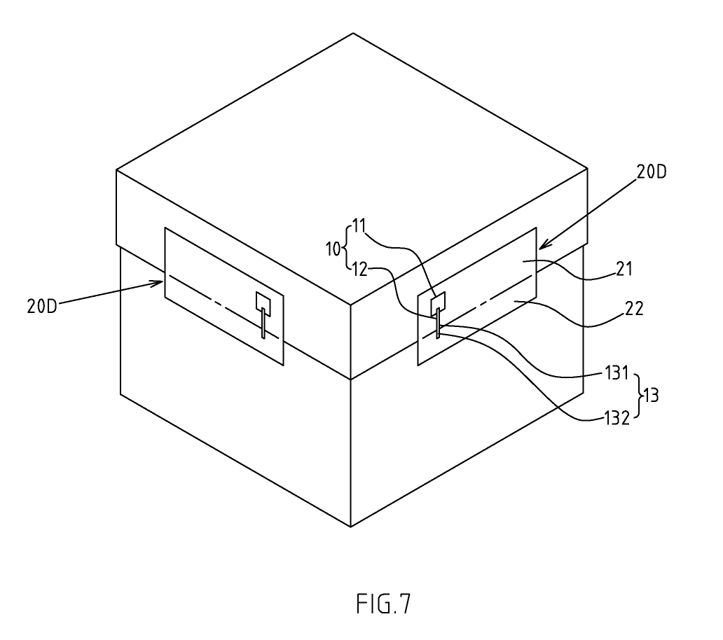

Referring to FIG. 7, said object 20D may be a seal, at each side of which there is separately the first portion 21 and second portion 22. The first part 131 of protruding end 13 of antenna 12 is fixed at the first portion 21, and the second part 132 is fixed at the second portion 22. When the seal is torn to separate the first portion 21 with the second portion 22, the second part 132 of protruding end 13 of antenna 12 will also be split from the first part 131, leading to damage of RFID tag 10.

The antenna 12 may be a 3D sheet, or a flat PCB, either of which can be put into operation with current production technologies.

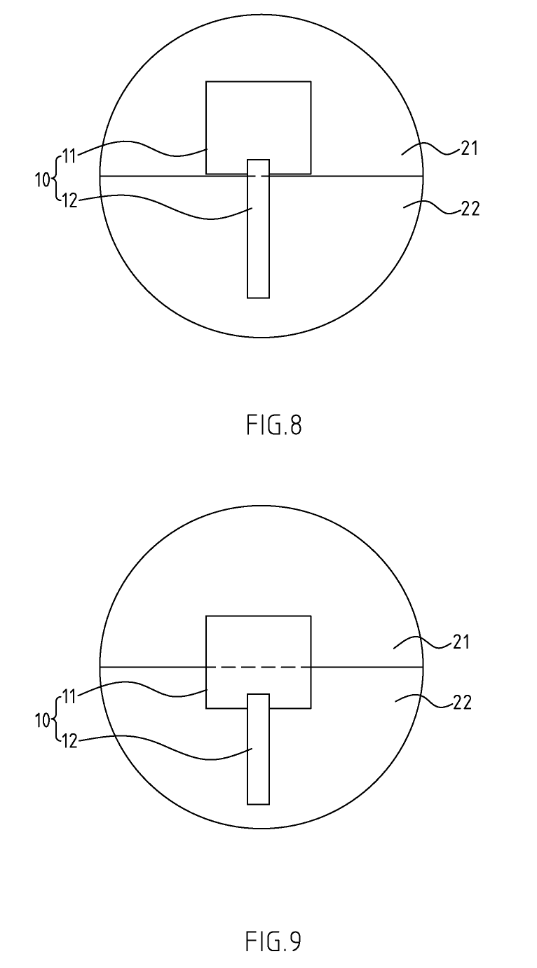

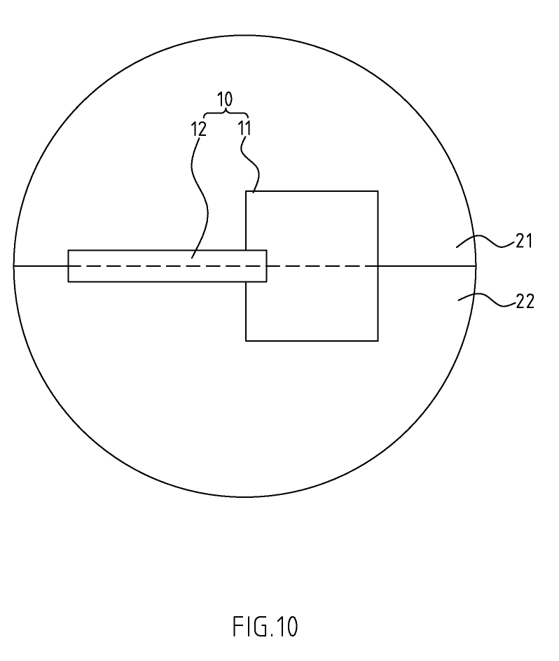

Additionally, as for RFID tag 10 of the preferred embodiment, the first and second portions 21, 22 of the object are able to be separated or split from each other, since the first part 131 of protruding end 13 of antenna 12 is split from the second part 132. Referring to FIG. 8, the antenna 12 and telecom IC 11 of RFID tag 10 are positioned between the first and second portions 21, 22 of the object. When the first and second portions 21, 22 are separated or misaligned, the antenna 12 will be separated from telecom IC 11, leading to damage of RFID tag 10. Referring also to FIG. 9, the telecom IC 11 of RFID tag 10 is also positioned between the first and second portions 21, 22 of the object. When the first and second portions 21, 22 are separated or misaligned, the telecom IC 11 will be torn apart, leading to damage of RFID tag 10. Referring also to FIG. 10, antenna 12 and telecom IC 11 of RFID tag 10 are positioned between the first and second portions 21, 22 of the object. When the first and second portions 21, 22 are separated or misaligned, both antenna 12 and telecom IC 11 may possibly be torn, thus leading to damage of RFID tag 10. The damage conditions of RFID tag 10 of the present invention include deformation, breaking of the antenna or damage to the telecom IC.

1. An RFID tag system, comprising:
an object, being comprised of a first portion and a second portion, the portions being able to be separated from or misaligned with each other; and
a RFID tag, assembled between the first and second portions of said object, said RFID tag comprising a telecom IC and an antenna linked to said telecom IC, said RFID being deformed or damaged when the first and second portions are separated or misaligned.

2. The system defined in claim 1, wherein the damage said RFID tag is damaged by deformation, breakage of antenna or damage of telecom IC.

3. The system defined in claim 1, wherein said object is a bottle cap comprising an inner cap and outer cap, said first portion being said inner cap, said second portion being said outer cap.

4. The system defined in claim 1, wherein said object is a packaging bag comprising a bag body and a tear tape at an opening of said bag body, said first portion being formed at said tear tape, said second portion being formed at said opening of said bag body.

5. The system defined in claim 1, wherein said object is a lifting card comprising a main card and a secondary card, said first position portion being formed at said main card, said second portion being formed at said secondary card.

6. The system defined in claim 1, wherein said object is a seal, said first portion being formed on part of said seal, said second portion being formed on part of said seal separate from said first portion.

7. The system defined in claim 1, wherein said antenna is a 3D sheet, or a flat PCB.
